(19) United States
(12) Patent Application Publication
(10) Pub. No.: US 2026/0368675 A1
(43) Pub. Date: Nov. 19, 2026

(54) A Computer-Implemented Process for Processing An Extraction Plan and Associated Hardware and Systems

(71) Applicant: DeepGreen Engineering Pte. Ltd.

(72) Inventors: Anthony O'SULLIVAN, Bulimba, Queensland (AU); Toby BUCKLEY, Palm Beach, Queensland (AU); Michael CLARKE, Palm Beach, Queensland (GB); Andrew JONES, London (GB); Jonathan Bruce MACHIN, Aboyne (GB)

(21) Appl. No.: 19/130,886

(22) PCT Filed: Nov. 17, 2022
(86) PCT No.: PCT/AU2022/051373

§ 371 Date: May 16, 2025

(51) Int. Cl. G06Q 10/0637; G06Q 50/02

(52) U.S. Cl. CPC G06Q 10/0637; G06Q 50/02

(57) ABSTRACT

An embodiment of the computer-implemented process is for processing an extraction plan for extraction of a natural resource from a target environment. The computing system conducts simulation processing to process environmental data, the operational data and plan data to simulate a state of the target environment once a predefined first time period has elapsed during which the extraction plan is simulated to have been implemented. The computing system also conducts constraint processing to process constraint data and the simulated state of the target environment to determine if any of the environmental constraints are simulated to have been breached. If none of the environmental constraints are simulated to have been breached, flag the extraction plan as compliant. The computing system also generates a plurality of alternate extraction plans and respective plan data and conducts simulation processing and constraint processing with respect to each of the respective plan data so as to flag a plurality of compliant extraction plans.

### TECHNICAL FIELD

The present invention relates to processes, associated apparatus and systems for use in the extractive industries. Embodiments of the present invention find application, though not exclusively, in fields such as logging, fisheries, terrestrial mining and deep-sea mining.

### BACKGROUND ART

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The management of extractive operations typically requires a delicate balance to be struck between inherently opposing considerations, such as maximising productivity whilst keeping environmental impacts within limits as stipulated by regulatory bodies having jurisdiction over the target environment. In general, an attempt to strike such a balance would be helped enormously by a detailed understanding of the target environment, and especially an ability to forecast and quantify the likely environmental impacts arising from various aspects of the proposed extractive activities. However, for many target environments, such information may be rudimentary, scarce or non-existent. This presents particular difficulties for entities wishing to commence extractive operations in little-known target environments, such as the deep sea, by way of non-limiting example.

### SUMMARY OF THE INVENTION

It is an object of the present invention to overcome, or substantially ameliorate, one or more of the disadvantages of the prior art, or to provide a useful alternative.

In one aspect of the present invention there is provided a computer-implemented process for processing an extraction plan for extraction of a natural resource from a target environment, the process including configuring a computing system to: have access to environmental data indicative of the target environment; have access to constraint data indicative of a plurality of environmental constraints applicable to the target environment; have access to operational data indicative of equipment deployed within the target environment; have access to plan data indicative of the extraction plan; conduct simulation processing to process the environmental data, the operational data and the plan data to simulate a state of the target environment once a predefined first time period has elapsed during which the extraction plan is simulated to have been implemented; conduct constraint processing to process the constraint data and the simulated state of the target environment to determine if any of the environmental constraints are simulated to have been breached and, if none of the environmental constraints are simulated to have been breached, flag the extraction plan as compliant; generate a plurality of alternate extraction plans and respective plan data and conduct simulation processing and constraint processing with respect to each of the respective plan data so as to flag a plurality of compliant extraction plans.

Preferably the process includes defining a metric for quantifying a desirability of an extraction plan, calculating a respective metric for each of the compliant extraction plans and, once a predefined second time period has elapsed, presenting the extraction plan having the highest metric to a user of the computing system for approval, wherein the predefined second time period is less than the predefined first time period.

In one embodiment, if an environmental constraint is simulated to have been breached with respect to an extraction plan, the computing system is configured to prompt a user of the computing system to select at least one of a plurality of pre-determined potential revisions to the extraction plan.

Preferably the simulation processing makes use of a digital twin configured to simulate a current operational state based upon operational data input from sensors, the digital twin being configurable to simulate future operational data during which an extraction plan is simulated to have been implemented.

Preferably the simulation processing makes use of probabilistic analysis to process the operational data and the future operational data so as to model cause and effect relationships for a plurality of indicators of environmental impact.

In one embodiment the generation of a plurality of alternate extraction plans and respective plan data includes incrementally modifying operational variables of an extraction plan to generate modified operational variables and processing the modified operational variables in an optimisation algorithm.

The generation of a plurality of alternate extraction plans and respective plan data may include randomly generating extraction plan starting parameters and processing the randomly generated starting parameters in an optimisation algorithm. Examples of such starting parameters include: a proposed extraction starting position within the target environment; a proposed extraction rate of the natural resource; a proposed efficiency level and a proposed power usage level.

An embodiment of the computing system maintains a mode indicator that is indicative of an active adaptive management state or a passive adaptive management state. In this embodiment, when the mode indicator is in the passive adaptive management state, the generation of a plurality of alternate extraction plans is constrained within a safe region of an operational envelope whereby the alternate extraction plans have a high likelihood of being compliant with the environmental constraints. When the mode indicator is in the active adaptive management state, the generation of a plurality of alternate extraction plans is skewed towards a border region of an operational envelope in which the alternate extraction plans are close to non-compliant with the environmental constraints or are non-compliant with the environmental constraints.

In one embodiment the computer system is responsive to a user input to toggle the mode indicator between the active adaptive management state and the passive adaptive management state. In another embodiment the computer system is configured to calculate an uncertainty score associated with the probabilistic analysis and, when the uncertainty score falls below a threshold, the computer system makes a recommendation to a user to set the mode indicator to the active adaptive management state and, when the uncertainty score raises above the threshold, the computer system automatically sets the mode indicator to the passive adaptive management state.

In one embodiment an extraction plan is operationally implemented during the predefined first time period and also the plurality of alternate extraction plans and respective plan data are generated during the predefined first time period. In one such embodiment, a starting operational parameter for at least some of the alternate extraction plans corresponds to a predicted operational parameter of the implemented extraction plan as at elapsing of the predefined second time period.

Some embodiments of the process include defining a third time period, wherein the third time period is greater than the second time period and wherein, once the third time period has elapsed, the computing system is configured to collate empirically derived environmental data and empirically derived operational data. This assists a research scientist and/or a data analysist to apply probabilistic techniques and/or machine learning techniques to the empirically derived environmental data and empirically derived operational data so as to update at least one of: the probabilistic analysis; the constraint data; acceptable levels of state change; and/or an ecosystem model. In some such embodiments, the second time period may be between 5 days and 6 months and the first and third time periods are each between 1 month and 1 year.

In some embodiments the computing system is configured to maintain a portal accessible to regulators and/or accessible to members of the public, the portal making at least one the following types of information available: environmental data; constraint data and operational data.

According to a third aspect of the invention there is provided a computing system configured to perform a process as described above.

According to another aspect of the invention there is provided a system for extraction of a natural resource from a target environment, the system including: a computing system configured to perform a process as described above; extraction equipment deployed in the target environment; and a plurality of sensors deployed on and about the extraction equipment and within the target environment, the sensors being in communications with the computing system via a telemetry link.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a schematic diagram depicting the architecture of an embodiment of a computing system according to the invention;

FIG. 2 is a schematic diagram depicting elements of environmental logic as implemented in an embodiment of a computing system according to the invention;

FIG. 3 is a flow chart depicting passive adaptive management as implemented in an embodiment of the invention;

FIG. 4 is a flow chart depicting active adaptive management as implemented in an embodiment of the invention;

FIG. 5 is a schematic diagram depicting the architecture of a digital twin as utilized in the embodiment of FIG. 1;

FIG. 6 is a flow chart depicting active adaptive management as implemented in an embodiment of the invention;

FIG. 7 is a flow chart depicting a process for extraction plan generation;

FIG. 8 is a flow chart depicting a process for using empirically derived data to update aspects of the system logic; and

FIG. 9 is a side view of a schematic depiction of a system for extraction of nodules from a seabed target environment.

### DETAILED DESCRIPTION OF PREFERRED EMBODIMENTS OF THE INVENTION

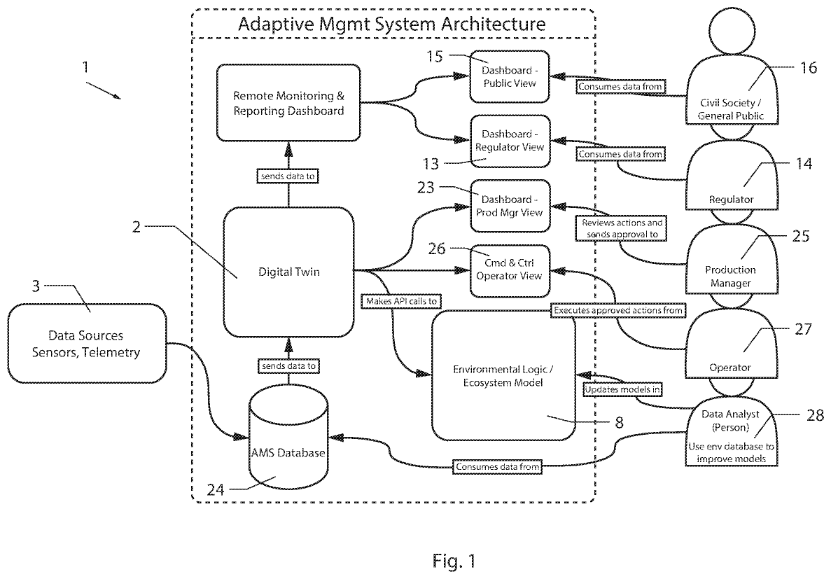

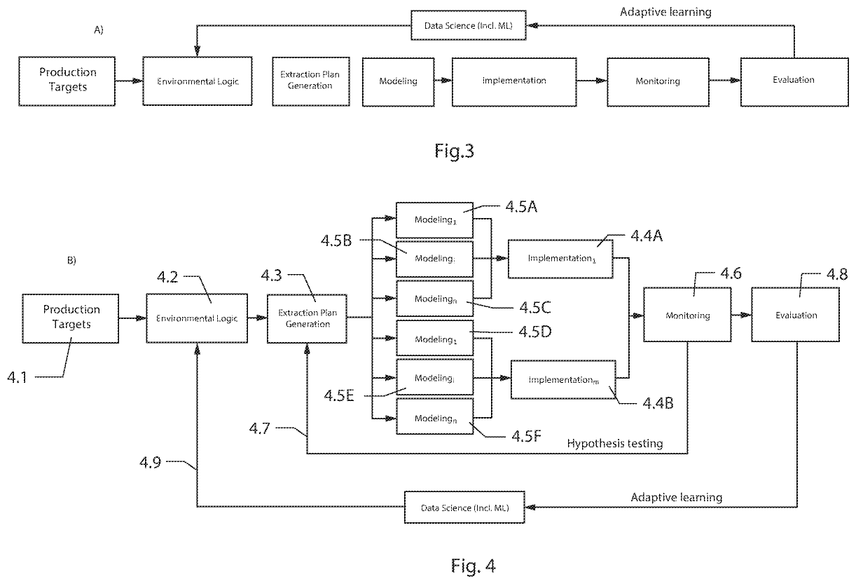

The computing system 1 is configurable to perform the processes depicted in FIGS. 3, 4, 6, 7 and 8. From a schematic viewpoint, the system architecture includes a number of communicatively interlinked modules as illustrated for example in FIG. 1.

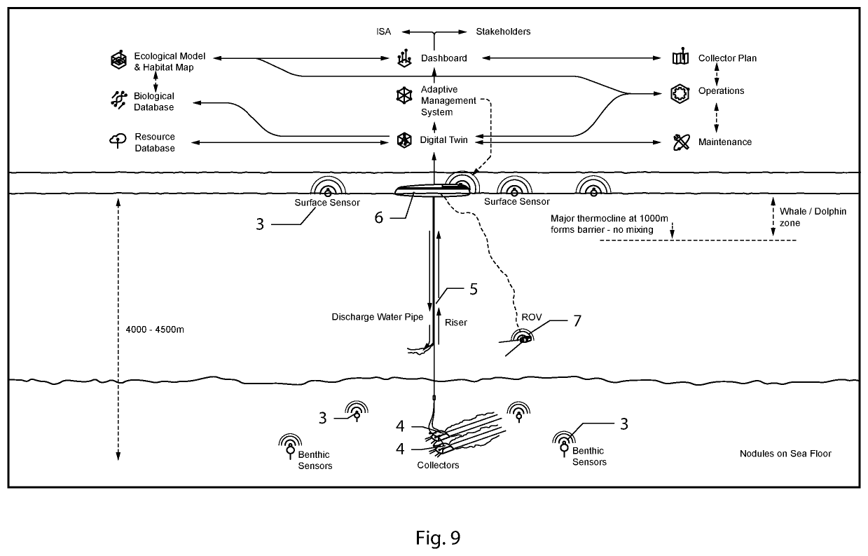

The computing system 1 is capable of being utilised in relation to a variety of different types of extractive industries, such as logging, fisheries, terrestrial mining and deep-sea mining, for example. One preferred implementation of the invention will focus upon the deep-sea mining example illustrated schematically in FIG. 9. However, it will be appreciated that those skilled in the art would be readily able to adapt the general concepts of this invention for application in other types of extractive industries.

The deep-sea mining example involves extraction of nodules resting upon the seabed at a depth of approximately 4000 to 4500 meters. This extractive system entails a plurality of collectors 4, which roam across the seabed to collect the nodules using jets of water. Typically, this nodule extraction process involves the lifting of a surface layer of seabed sediment, which is likely to cause a sediment plume to move within the ocean water currents. This provides a non-limiting example of the type of operational activity and associated environment impact that the computing system 1 is configured to analyse and predict. Once collected by the collectors 4, the nodules are displaced by compressed air bubbles up a substantially vertical tube, referred to as a riser 5, which delivers the nodules to a vessel 6 for subsequent processing.

In a typical embodiment, the modules of the computing system 1 may be implemented in a cloud computing context. However, as outlined in more detail below, the sensors 3 are disposed within and around the target environment and workstations 21 are provided upon the vessels 6 to run software necessary for the telemetry links between the sensors 3 and the various modules of the computing system 1 in the cloud. Some examples of publicly or commercially available software modules that may be used in a preferred embodiment include:
the Kognitwin digital twin by Kongsberg;
computational fluid dynamics as provided by DHI Group;
open-source software for the Bayesian network; and/or
database services provided by InfluxDB by InfluxData or Dremio.

Prior to commencement of the above-mentioned deep-sea extractive activities, it is necessary to give the computing system access to various types of data. In some embodiments this some or all of this data is stored in a locally accessible database 24. In other embodiments some or all of this data is stored in a cloud computing data storage facility or is accessible to the computing system 1 via a subscription to a third-party data provision service. This data includes environmental data, which helps populate the environmental logic module 8 and the ecosystem model 9. The first time the process flow illustrated in FIG. 4 proceeds to step 4.2, the environmental data is collected. This typically includes environmental baselines, which are established by collecting samples from the target environment. The samples are taken to a laboratory and analysed to identify the makeup of the ecosystem including the key species. The formulation of the ecosystem model 9 allows for modelling of the food web of the target environment. The food web analysis includes considerations of nutrient inputs and outputs and interrelationships between various species, including predation, scavenging, etc. This process generates environmental data indicative of the target environment to which the computing system 1 has access. This provides a baseline against which environmental state change caused by the human impacts of the extractive activities can be measured.

In some contexts, aspects of the environmental data may be made accessible to the computing system 1 from the public domain or from commercial sources such as subscriptions to third party databases. In the deep-sea context, data relating to oceanic currents may be available in this fashion.

The pre-production steps typically also involve consultation with experts to formulate and quantify key ecosystem indicators, such as the counting of the various key species. In the deep-sea extractive context, examples of key ecosystem indicators may include:
Benthic plume deposition;
Definition of preservation areas;
Plume dispersal;
Key fauna species counts;
Noise generation;
Key microbial species counts;
eDNA analysis;
Cultural and/or scientific DGM programs;
Water chemistry;
Fauna heavy metal content;
Organic matter flux;
Nitrification concentrations in water and pore-water;
Pore-water chemistry;
Phytoplankton density/Biomass;
Nutrient concentrations;
Water Chemistry;
Plankton community composition;
Sediment properties;
Caste density; and
Sediment radiochemistry.

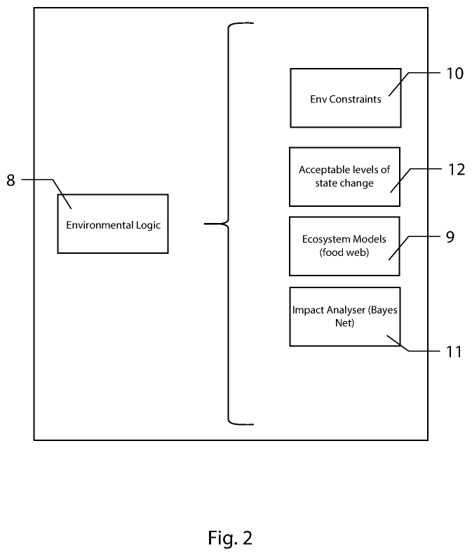

Individual components of the environmental logic module 8 are illustrated in FIG. 2. In addition to the ecosystem model 9, the environmental logic module 8 provides the computing system 1 with access to constraint data 10 indicative of a plurality of environmental constraints applicable to the target environment. This constraint data 10 is essentially a practical representation of the environmental regulations that are applicable to the target environment and to which the extractive activities are subject. This may include data indicative of the environmental aspects that must be tracked. The environmental logic also includes data indicative of the acceptable levels of environmental state change 12. In a deep-sea mining context, one example of the types of constraints that may be coded into the constraint data include constraints relating to suspended and deposited sediment caused by the operation of the collectors 4, as shown below.

| Environmental | | | Constraint | |
|---|---|---|---|---|
| Constraint | Sensor Type | Description | Value | |
| Sediment thickness in | ROV LISST- | Thickness of newly | 1 | mm |
| Areas of Particular | STX | settled sediment on | | |
| Environmental Interest | | the seabed | | |
| Plume Turbidity in | ROV Niskin | Turbidity is a | 10 | NTU |
| Areas of Particular | Bottle Array | measure of how | | |
| Environmental Interest | | much light passes | | |
| | | through liquid with | | |
| | | particles in it | | |
| Plume Total | ROV LISST- | TSS is total | 5 | mg/L |
| Suspended Solids (TSS) | 200X | suspended solids | | |
| in Areas of Particular | | and is a measure | | |
| Environmental Interest | | of the suspended | | |
| | | particles | | |

Another example of a type of constraint that may be applicable in deep-sea mining context, and which is coded into the constraint data, is noise generated by the extractive operations, which carries through the environment and may disrupt the ecosystem. Such a constraint may be that the noise levels generated by operating the collectors 4 and the riser 5, as measured at a far-field buoy spaced from the site of operation are not to exceed 75 dB.

In a terrestrial mining context, some examples of constraint data that may be coded into the computing system are as follows:

| Environmental | | |
|---|---|---|
| Constraint | Sensor Type | Description |
| Preserved | Satellite | A certain amount of forest must be set |
| Forests | imagery | aside to preserve biodiversity & |
| | | ecosystem function |
| Rate of | Satellite | The rate of forest removal must be below |
| deforestation | imagery | a threshold |
| Biodiversity | Ecosystem | Level of biodiversity as estimated using |
| | model | an ecosystem model along with a |
| | | topography map |

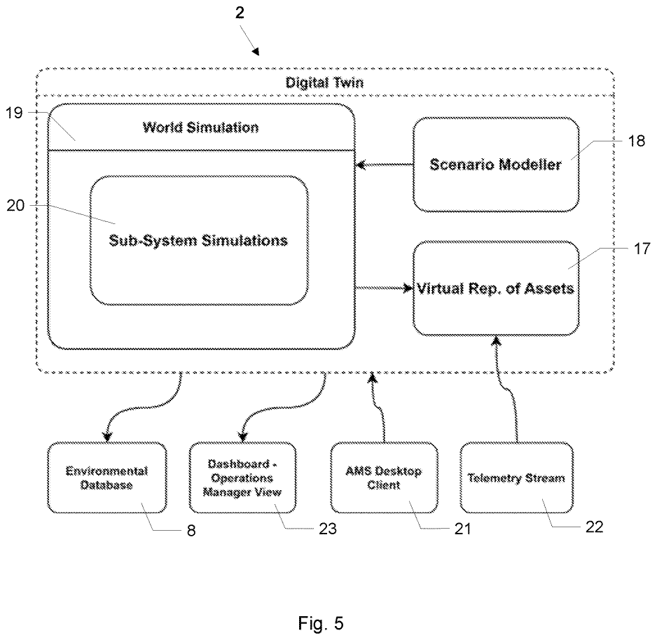

As shown in FIG. 5, the digital twin 2 maintains a virtual representation of assets 17, which is configured to track a current operational state of the physical assets used in the extractive system, such as the collectors 4, the riser 5, the nodule-receiving vessel 6, the remotely operated vehicles 7, moorings, buoys, environmental monitoring vessel, etc. This is based upon operational data input from sensors 3 that are deployed on and about the extraction equipment and within the target environment. Examples of the operational data include data such as: equipment locations; equipment speeds; extraction rate; efficiency; power consumption; material handling variables; logistics variables, etc. Some of the sensors 3 as deployed within a deep-sea target environment are illustrated in FIG. 9.
The nodule-receiving vessel 6 has:
   a return water sampler that senses return water quality, turbidity, oxygen levels, oxidation-reduction levels, pH, nitrate levels and nutrition levels;
   an air pollution sensor that senses CO, NOₓ, SO₂ and VOC;
   a Sound Level Meter for measuring atmospheric noise levels;
   an electromagnetic flow sensor for measuring return water flow velocity, return water flow rate, return water CO₂ level and return water temperature;
   a multi belt scale for measuring conveyor belt throughput;
   a global navigation satellite system for monitoring heading, speed, x-location and γ-location; and
   a hydrophone for measuring underwater noise levels.
The riser 5 at the mid-column position has:
   an ultra-short baseline transponder for measuring x-position, y-position and depth;
   a hydrophone for measuring underwater noise levels; and
   a CTD probe for measuring conductivity, temperature and depth.
The base of the riser 5 the has:
   an underwater acoustic positioning transponder for measuring x-position, y-position and depth; and
   a hydrophone for measuring underwater noise levels.
Each collector 4 has:
   a Submersible Particle Size Analyzer for measuring turbidity and total suspended solids;
   a light sensor for measuring light levels;
   a hydrophone for measuring underwater noise levels;
   a power meter for measuring power consumption;
   a densitometer for measuring discharge density;
   a flow sensor for measuring discharge flow rate;
   a densitometer for measuring jumper hose density;
   a pressure sensor for measuring water pressure;
   a flow sensor for measuring jumper hose flow rate;
   a Doppler Velocity Logger for measuring collector speed over the seabed;
   an Inertial Navigation System for measuring collector heading; and
   an underwater acoustic positioning transponder for measuring x-position, y-position and depth.
Each remotely operated vehicle 7 has:
   a bottle water sampler for measuring water quality;
   a turbidity sensor for measuring turbidity;
   an Inertial Navigation System for measuring heading, roll and pitch;
   an underwater acoustic positioning transponder for measuring x-position, y-position and depth;
   a CTD probe for measuring conductivity, temperature and depth;
   a hydrophone for measuring underwater noise levels; and
   a light sensor for measuring light levels.
Each of the moorings has:
   an Acoustic Doppler Current Profiler for measuring ocean current, speed and direction;
   a hydrophone for measuring underwater noise levels;
   a water sampler for measuring water quality, turbidity, oxygen levels, oxidation-reduction levels, pH, nitrate levels and nutrition levels; and
   a CTD probe for measuring conductivity, temperature and depth.
Each of the buoys has:
   an Acoustic Doppler Current Profiler for measuring ocean current, speed and direction.

The extractive system also makes use of satellite imagery for measuring animal migratory patterns and operating fleet discharge.

The sensors 3 are in communications with the computing system 1 via a telemetry stream 22 whereby each of the sensors 3 is in communications with a central control station 21 provided upon a ship 4 floating in the vicinity of the equipment performing the extractive operations.

The digital twin also makes use of a scenario modeller 18 to simulate future operational data that is predicted to be appliable to the extractive equipment when an extraction plan is simulated to be implemented.

The environmental logic module 8 also includes an impact analyser 11 configured to use probabilistic analysis to process the operational data and the future operational data so as to model cause and effect relationships for a plurality of indicators of environmental impact, such as the key ecosystem indicators. The preferred embodiment makes use of a Bayesian network for the probabilistic analysis, which is configured to take a current state of the environment, the ecosystem model and a proposed extraction plan as inputs that are processed to output a likely range of environmental state changes. Configuration of the Bayesian network is performed by one or more research scientists and/or data analysists 28 using known techniques to assign probabilities within the Bayesian network.

If initially configured based solely, or mainly, upon the opinions of experts, the outputs of the Bayesian network are likely to have a high degree of uncertainty. That is, the range of environmental state changes as predicted by the Bayesian network is likely to be relatively broad. For this reason, a cautious approach should be taken to the initial operation of the extractive system. This necessitates the use of conservative extraction plans early in the project life cycle and may also necessitate initial extractive activities to be initially located in areas deemed to be of higher environmental resilience. The aim is for the system to support the key project personnel in promoting a precautionary approach that emphasizes proactive decision making to manage risks. This approach also promotes the delaying of potentially harmful decisions until a sufficiently detailed understanding of applicable causal relationships has been achieved. The use of active adaptive management techniques, as shown in FIG. 4, allows the extractive system to safely explore operational states for which there is no or minimal data. Once a historical record of empirically derived data has been compiled due to the completion and monitoring of actual extractive activities, this empirically derived data is used to refine the configuration of the Bayesian network by one or more research scientists and/or data analysists 28. Each time this re-configuration is performed, the predictions from the probabilistic analysis will typically have lower uncertainty. That is, the range of environmental state changes as predicted by the Bayesian network is likely to be narrower for a given confidence interval. As this state is reached, the initial cautious approach can be progressively replaced with a more aggressive approach to an extent justified by the certainties of the predictions of the probabilistic analysis. Once the operational state space has been sufficiently explored, and the user deems it appropriate, the active adaptive management techniques can be replaced with the more traditional passive adaptive management techniques illustrated in FIG. 3.

The computing system 1 maintains a mode indicator that is indicative of whether the system is currently desired to operate in an active adaptive management state or a passive adaptive management state. It will be appreciated that passive adaptive management as illustrated in FIG. 3, executes a single management strategy before collecting new data and re-evaluating if that management strategy was effective. In contrast, as depicted in FIG. 4, active adaptive management compares multiple management strategies to a control using models and data derived from implementation of the extractive activities.

In one embodiment the computer system is responsive to a user input to toggle the mode indicator between the active adaptive management state and the passive adaptive management state. In another embodiment the computer system 1 is configured to calculate an uncertainty score associated with the probabilistic analysis and, when the uncertainty score falls below a threshold, the computer system makes a recommendation to a user to set the mode indicator to the active adaptive management state. When the uncertainty score raises above the threshold, the computer system automatically sets the mode indicator to the passive adaptive management state. Avoiding allowing the computing system 1 to automatically set the mode indicator to the active adaptive management state is a safety feature because the mode cannot be changed to the active adaptive management state without the awareness and agreement of a user of the system.

To commence the process illustrated in FIG. 4, a user of the computer system 1, typically a Production Manager, establishes an initial proposed extraction plan for extraction of the natural resource from the target environment. In practice, it may be possible for more than one extraction plan to be implemented simultaneously at differing sites within the target environment and the example illustrated in FIG. 4 entails two extraction plans being implemented simultaneously. However, it will be appreciated that other embodiments may simultaneously implement less or more than two extraction plans. The establishment of one or more initial extraction plans can be done at a number of possible levels of specificity. At the highest level, this may merely involve stipulating proposed production targets and proposed regions of the target environment in which the extraction is to take place. At lower levels it includes defining more operational details for the proposed extractive activities. Optionally, the initial proposed extraction plans could also include other desired parameters such as efficiency, power usage, etc. This is inputted into the computing system 1 and is stored as plan data for further processing. For the example shown in FIG. 4, at step 4.1 the Production Manager inputs plan data for the two extraction plans that are proposed to be implemented simultaneously.

The data indicative the two initial proposed extraction plans is subject to a ‘sanity check’, which involves processing by the physics simulation module of the computing system 1 to check if it is physically possible for the two initial proposed extraction plans to be implemented. If physically impossible, the user is prompted to revise the initial proposed extraction plan(s).

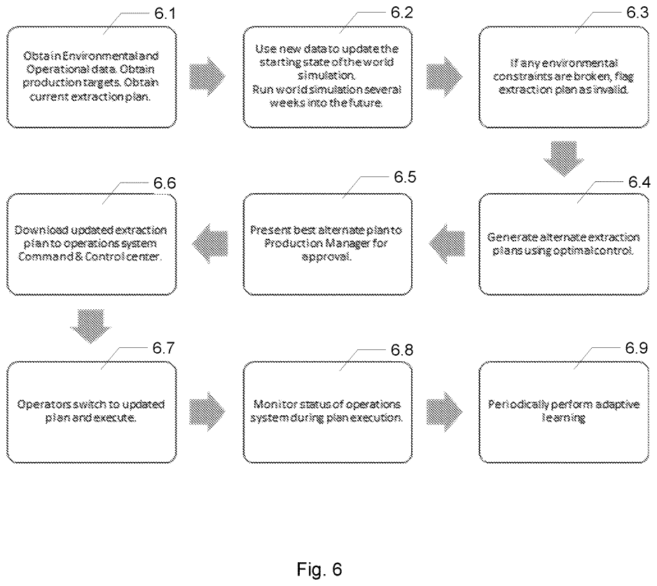

Assuming that the ‘sanity check’ is passed, the data indicative of the two initial proposed extraction plans is processed by an optimisation algorithm, such as a Multi-disciplinary Design Optimization engine. The MDO engine is configured to process the plan data and the environmental logic 8 to generate specific details for each of the two initial proposed extraction plans that comply with the specified initial conditions. This includes productivity targets, rate of resource collection, detailed proposed trajectories, with associated time stamps, for any moveable pieces of operational equipment such as the collectors 4, the riser 5, and vessels 6, the ROVs 7, a schedule of operation, etc. It also includes proposed flow rates for riser flow and other associated operational data. In some embodiments, as illustrated at steps 6.1 to 6.3 of FIG. 6, an initial compliance check is performed, which includes simulation processing of the environmental data, the operational data and the plan data for each of the two initial proposed extraction plans to determine if any of the environmental constraints 10 are simulated to have been breached by either of the initial proposed extraction plans. If this simulation predicts that either of the initial proposed extraction plans is likely to breach any of the environmental constraints 10, the computing system 1 is configured to flag the applicable extraction plan as invalid at step 6.3 and prompt the user to revise the applicable extraction plan at step 6.4 so as to generate an alternate extraction plan for operational implementation. This may involve the user selecting at least one of a plurality of pre-determined potential revisions to that extraction plan, such as a 10% reduction in the production target, or shifting of the proposed extraction site to a less sensitive region, or away from a protected site, for example.

If a tracked ecosystem variable is predicted to come close to an acceptable range threshold, but not surpass it, then increased monitoring is triggered. This improves the system's ability to more accurately predict if the at-risk indicator will breach a constraint.

Once the two initial proposed extraction plans have passed the above-mentioned checks, and have been approved by any necessary personnel, they are provided to the operational staff to commence parallel implementation of the two extraction plans within the target environment at steps 4.4A and 4.4B. At the start of that parallel implementation, the computing system 1 commences a timer, which is used as the starting point for three time periods. The first time period is the period over which the simulations are conducted. In a typical implementation, the first time period is likely to be between about 1 month and about 1 year.

The second time period is the period over which the two initial extraction plans will be implemented in parallel within the target environment and this is less than the first and third time periods. Typically, the second time period is likely to be between about 5 days and about 6 months. As will be explained in detail below, during this second time period, a plurality of alternate extraction plans is generated and simulated.

Having a longer first time period as compared to the second time period means that techniques from Model Predictive Control may be implemented. That is, the simulated time period covered by the simulation processing is longer than the period of time for which it is proposed to operationally implement the initial two extraction plans. This longer time horizon advantageously allows for more thorough calculation of environmental impacts of the various extraction plans. Additionally, if, by the end of the second time period, the generation of a plurality of alternate compliant extraction plans were to fail, the longer time horizon allows the Production Manager to have confidence when deciding whether or not to continue to implement the two initial extraction plans. This is because the environmental impacts have already been predicted for a period of time extending beyond the end of the second time period.

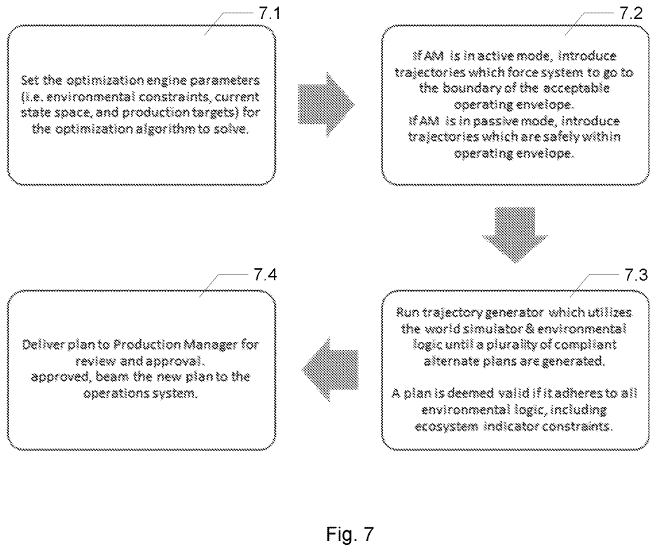

As shown in FIG. 4, six alternate extraction plans are generated at step 4.3. This generation process is illustrated in more detail in FIG. 7. This process makes use of the optimisation algorithm mentioned above. However, rather than receive the optimisation parameters from the user, in this case the computer system 1 is configured at step 7.1 to automatically generate alternate starting parameters for the optimisation. Two of the six alternate extraction plans will be chosen to be implemented at the end of the predefined second time period. Hence, the starting operational parameters for a first set of three alternate extraction plans, 4.5A, 4.5B and 4.5C, correspond to predicted operational parameters of one of the implemented extraction plans, 4.4A, as at elapsing of the predefined second time period. This means that the state of the operational equipment for implemented extraction plan 4.4A as at the end of the predefined second time period will be concordant with the simulated starting states of the operational equipment for the three alternate extraction plans 4.5A, 4.5B and 4.5C. Similarly, the starting operational parameters for a second set of three alternate extraction plans, 4.5D, 4.5E and 4.5F, correspond to predicted operational parameters of the other of the implemented extraction plans, 4.4B, as at elapsing of the predefined second time period. This means that the state of the operational equipment for implemented extraction plan 4.4B as at the end of the predefined second time period will be concordant with the simulated starting states of the operational equipment for the three alternate extraction plans 4.5D, 4.5E and 4.5F.

One strategy for generating the alternate starting parameters for processing by the MDO engine to generate the alternate extraction plans is for the computing system 1 to be configured to incrementally modify the starting parameters (e.g., some of the operational variables), of the two user-generated extraction plans. Examples of such operational variables that may be incrementally modified include: a proposed extraction starting position within the target environment; a proposed extraction rate of the natural resource; a proposed efficiency level; a proposed power usage level; way points (x, y, depth) of each collector's trajectory; collection rates associated with each way point; speed of collectors 4, etc. Another strategy for generating the alternate starting parameters for the optimisation is for the computing system 1 to be configured to randomly generate extraction plan starting parameters. This random element helps avoid any local minima that may be associated with the user-generated extraction plan. However, it will be appreciated that not all starting parameters can be changed and the randomly generated starting parameters must be simulated within the physics simulator to ensure that they are achievable within the laws of physics. Typically, both of the above-mentioned strategies will be used to generate a plurality of sets of alternate optimisation starting parameters at step 7.1.

At step 7.2, the computing system 1 tailors the optimisation algorithm depending upon the current status of the mode indicator. If the mode indicator is in the passive adaptive management state, the optimisation algorithm is tailored to ensure that the generation of the plurality of alternate extraction plans is constrained within a safe region of the operational envelope. In other words, the alternate extraction plans that are generated by using the MDO engine to optimise based upon the sets of alternate optimisation starting parameters will have a high likelihood of being compliant with the environmental constraints.

If the mode indicator is in the active adaptive management state, the optimisation algorithm is tailored to ensure that the generation of the plurality of alternate extraction plans is skewed towards a border region of the operational envelope. In other words, the alternate extraction plans that are generated by using the MDO engine to optimise based upon the sets of alternate optimisation starting parameters will be either close to non-compliant with the environmental constraints 10 or non-compliant with the environmental constraints 10. In one embodiment, the computing system 1 maintains a variable that defines the extent of this skewing. At the completion of the MDO engine optimisations, a plurality of alternate extraction plans and respective plan data has been generated.

Each of the six alternate extraction plans is then subject to simulation processing at steps 4.5A, 4.5 B, 4.5C, 4.5D, 4.5E and 4.5F (also refer to step 7.3 of FIG. 7). The example shows a total of six alternate extraction plans. In practice, however, as many alternate extraction plans as are computationally possible would typically be generated, simulated and compliance checked within second time period. The simulation processing processes the environmental data, the operational data and the plan data for each of the six alternate extraction plans to simulate a respective state of the target environment once the predefined first time period has elapsed during which each of those alternate extraction plans is simulated to have been implemented. In other words, this simulation processing determines, for each of the alternate extraction plans, a range of predicted end states of the target environment after each of the alternate extraction plans has been simulated as having been implemented for a length of time equal to the first time period.

The simulation processing takes as input the time-series history of operational and environmental data, along with the plan data for the alternate extraction plans as generated by the MDO engine optimisations and uses them to run simulations of the future. The simulations are run into the future to cover the predefined first time period using a world simulator 19 and a collection of sub-system simulators 20, such as a materials processing simulator, a biology simulator and a physics simulator. For example, the physics simulator is used by the computing system 1 in conjunction with ocean current forecast data to simulate the sediment plume spread and settling.

A probabilistic analysis using the Bayesian network is ran using the final states of the simulations to determine the most likely ranges of values for the key ecosystem indicators for each of the alternate extraction plans as at the end of the predefined first time period. In the deep-sea mining example, the key ecosystem indicators include:

### Primary Production

Surface Photosynthesis
   Phytoplankton Density/Biomass
   Nutrient Concentrations
Chemosynthesis
   Water Chemistry
Carbon Flux
   Plankton Community Composition
Bioturbation
   Sediment Properties
   Caste Density
   Sediment Radiochemistry

### Biodiversity

Habitat Integrity
   Plume Deposition (Benthic)
   Integrity of Preservation Areas
   Plume Dispersal (Mid-Water)
Fauna Characterization
   Key Species Counts
   Noise Generation
Microbial Diversity
   Key Species Counts
Trophic Support
   eDNA Analysis

A 90% confidence interval is used to determine the likely range of values for each ecosystem indicator for each of the alternate extraction plans. If any part of the range of likely values is outside the acceptable range of values, then the applicable alternate extraction plan is flagged as non-compliant.

The output of the above-mentioned simulation processing allows for a calculation of the degree of human impact resulting from the simulated extractive activities of each of the six alternate extraction plans by subtracting the final simulated environment states from the initial simulated environment states. This allows constraint processing to be conducted whereby the constraint data and the simulated state of the target environment for each of the six alternate extraction plans are processed to determine if any of the environmental constraints are simulated to have been breached. If none of the environmental constraints are simulated to have been breached for one of the alternate extraction plans, the computing system 1 is configured to flag that extraction plan as compliant. If at least one of the environmental constraints is simulated to have been breached for one of the alternate extraction plans, the computing system 1 is configured to flag that extraction plan as non-compliant. Hence, by the end of the second time period, the aim is to have compiled a plurality of compliant simulated alternate extraction plans.

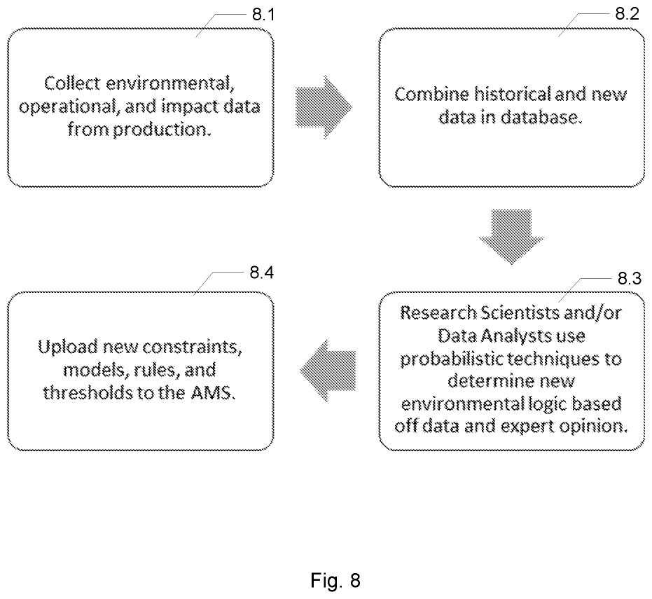

The above-mentioned simulation processing and constraint processing occurs in parallel with the operational implementation of the two extraction plans during the predefined second time period. During this implementation, the computing system 1 continues to monitor the data coming from the sensors 3, as shown at step 4.6. This empirically derived environmental data and the empirically derived operational data is stored by the computing system 1 for later usage (also refer to step 6.8 of FIG. 6 and to step 8.1 of FIG. 8).

At the end of the second time period, the computing system 1 is configured to calculate a metric for each of the six alternate extraction plans. This metric is formulated to quantify the desirability of the extraction plan for which it is calculated. It is typically calculated by taking a weighted average of various criteria. The three metrics for the first set of alternate extraction plans 4.5A, 4.5B and 4.5C are compared and the alternate extraction plan having the highest metric is presented to the Production Manager for approval to be implemented next (also refer to step 6.5 of FIG. 6). Similarly, the three metrics for the second set of alternate extraction plans, 4.5D, 4.5E and 4.5F, are compared and the alternate extraction plan having the highest metric is also presented to the Production Manager for approval to be implemented next. Once approved, the process flow loops through inner loop 4.7 and re-commences with implementation of the two newly approved extraction plans (also illustrated at steps 6.6 and 6.7 of FIG. 6).

The inner loop 4.7 continues looping as described above until the third time period has elapsed. In a typical implementation, the third time period is likely to be between about 1 month and about 1 year. Once the third time period has elapsed, the computing system 1 is configured to collate the previously stored environmental data and operational data that was empirically derived during the inner looping as illustrated in FIG. 4 (also refer to step 8.2 of FIG. 8). At step 4.8 (also refer to step 6.9 of FIG. 6 and step 8.3 of FIG. 8) one or more research scientists and/or data analysists 28 apply probabilistic techniques and/or machine learning techniques to the empirically derived environmental data and empirically derived operational data so as to update any of: the probabilistic analysis; the constraint data 10; the acceptable levels of state change 12; and/or the ecosystem model 9. The process flow proceeds via the outer loop 4.9 back to step 4.2 at which the environmental logic 8 is updated (also refer to step 8.4 of FIG. 8). Hence, the environmental logic 8 is now no longer as dependent upon the experts' initial input. Rather, it has now been updated with reference to empirically derived data and hence the future predictions arising from simulations using the environmental logic 8 are likely to benefit from improved certainty. This improved certainty allows the computing system 1 the freedom, when subsequently performing the steps 4.3 to 4.7 of the inner loop, to generate alternate extraction plans that safely explore closer to the outer edges of the operational envelope.

As best shown in FIG. 1, the computing system 1 is configured to maintain a portal 13 that is accessible to regulators 14. The computing system 1 also maintains a portal 15 that is accessible to members of the public. The user of the computing system 1 can tailor these portals 13, 15 to select the information to be made available. This selection is made from amongst the environmental data, constraint data and operational data. Typically, the portal 13 that is accessible to regulators 14 is likely to include more detailed information as compared to the information made available via the public portal 15. The computing system 1 is also configured to maintain a pair of dashboards 23 and 26 summarising key information drawn mainly from the digital twin 2 that is likely to be respectively required by an Operations Manager 25 and by an Operator 27 of the extractive equipment.

Embodiments of the invention take as input environmental and production data in near-real-time, and output extraction plans, strategies, mitigations, actions, visualization of data, and controls for the human operators to enact. This helps promote an environmental management strategy that is adaptive to current operating conditions and future predicted states and is also sensitive to the system's statistical confidence in the cause-effect relationships defined in its ecosystem model. This approach involves continual testing of hypotheses, collection of data, and updating of environmental parameter values to allow operations to be adapted to the current state, and the predicted future state, of the impacted environment. Embodiments of the invention allow the key personnel to change the location, approach and specifications of the extraction plans based on changes in environmental factors and those operational changes are actionable within weeks rather than months or years. Importantly, embodiments of the invention allow dynamic changes to extraction plans to occur during operations. This compares well to the prior art in which such changes can typically only be made prior to the commencement of extractive activities.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A computer-implemented process for processing an extraction plan for extraction of a natural resource from a target environment, the process including configuring a computing system to:
have access to environmental data indicative of the target environment;
have access to constraint data indicative of a plurality of environmental constraints applicable to the target environment;
have access to operational data indicative of equipment deployed within the target environment;
have access to plan data indicative of the extraction plan;
conduct simulation processing to process the environmental data, the operational data and the plan data to simulate a state of the target environment once a predefined first time period has elapsed during which the extraction plan is simulated to have been implemented;
conduct constraint processing to process the constraint data and the simulated state of the target environment to determine if any of the environmental constraints are simulated to have been breached and, if none of the environmental constraints are simulated to have been breached, flag the extraction plan as compliant;
generate a plurality of alternate extraction plans and respective plan data and conduct simulation processing and constraint processing with respect to each of the respective plan data so as to flag a plurality of compliant extraction plans.

2. A computer-implemented process according to claim 1 including defining a metric for quantifying a desirability of an extraction plan, calculating a respective metric for each of the compliant extraction plans and, once a predefined second time period has elapsed, presenting the extraction plan having the highest metric to a user of the computing system for approval, wherein the predefined second time period is less than the predefined first time period.

3. A computer-implemented process according to claim 1 wherein, if an environmental constraint is simulated to have been breached with respect to an extraction plan, the computing system is configured to prompt a user of the computing system to select at least one of a plurality of pre-determined potential revisions to the extraction plan.

4. A computer-implemented process according to claim 1 wherein the simulation processing makes use of a digital twin configured to simulate a current operational state based upon operational data input from sensors, the digital twin being configurable to simulate future operational data during which an extraction plan is simulated to have been implemented.

5. A computer-implemented process according to claim 4 wherein the simulation processing makes use of probabilistic analysis to process the operational data and the future operational data so as to model cause and effect relationships for a plurality of indicators of environmental impact.

6. A computer-implemented process according to claim 1 wherein the generation of a plurality of alternate extraction plans and respective plan data includes incrementally modifying operational variables of an extraction plan to generate modified operational variables and processing the modified operational variables in an optimisation algorithm.

7. A computer-implemented process according to claim 1 wherein the generation of a plurality of alternate extraction plans and respective plan data includes randomly generating extraction plan starting parameters and processing the randomly generated starting parameters in an optimisation algorithm.

8. A computer-implemented process according to claim 7 wherein the starting parameters include at least one of: a proposed extraction starting position within the target environment; a proposed extraction rate of the natural resource; a proposed efficiency level and a proposed power usage level.

9. A computer-implemented process according to claim 5 wherein the computing system maintains a mode indicator that is indicative of an active adaptive management state or a passive adaptive management state.

10. A computer-implemented process according to claim 9 wherein, when the mode indicator is in the passive adaptive management state, the generation of a plurality of alternate extraction plans is constrained within a safe region of an operational envelope whereby the alternate extraction plans have a high likelihood of being compliant with the environmental constraints.

11. A computer-implemented process according to claim 10 wherein, when the mode indicator is in the active adaptive management state, the generation of a plurality of alternate extraction plans is skewed towards a border region of an operational envelope in which the alternate extraction plans are close to non-compliant with the environmental constraints or are non-compliant with the environmental constraints.

12. A computer-implemented process according to claim 9 wherein the computer system is responsive to a user input to toggle the mode indicator between the active adaptive management state and the passive adaptive management state.

13. A computer-implemented process according to claim 11 wherein the computer system is configured to calculate an uncertainty score associated with the probabilistic analysis and, when the uncertainty score falls below a threshold, the computer system makes a recommendation to a user to set the mode indicator to the active adaptive management state and, when the uncertainty score raises above the threshold, the computer system automatically sets the mode indicator to the passive adaptive management state.

14. A computer-implemented process according to claim 1 including operationally implementing an extraction plan during the predefined second time period and also generating the plurality of alternate extraction plans and respective plan data during the predefined second time period.

15. A computer-implemented process according to claim 14 wherein a starting operational parameter for at least some of the alternate extraction plans corresponds to a predicted operational parameter of the implemented extraction plan as at elapsing of the predefined second time period.

16. A computer-implemented process according to claim 5 including defining a third time period, wherein the third time period is greater than the second time period and wherein, once the third time period has elapsed, the computing system is configured to collate empirically derived environmental data and empirically derived operational data.

17. A computer-implemented process according to claim 16 wherein a research scientist and/or a data analysist applies probabilistic techniques and/or machine learning techniques to the empirically derived environmental data and empirically derived operational data so as to update at least one of:
the probabilistic analysis;
the constraint data;
acceptable levels of state change; and/or
an ecosystem model.

18. A computer-implemented process according to claim 16 wherein the second time period is between 5 days and 6 months and wherein the first and third time periods are each between 1 month and 1 year.

19. A computer-implemented process according to claim 1 wherein the computing system is configured to maintain a portal accessible to regulators and/or accessible to members of the public, the portal making at least one the following types of information available: environmental data; constraint data and operational data.

20. A computing system configured to perform a process as defined in claim 1.

21. A system for extraction of a natural resource from a target environment, the system including:
a computing system configured to perform a process as defined in claim 1;
extraction equipment deployed in the target environment; and
a plurality of sensors deployed on and about the extraction equipment and within the target environment, the sensors being in communications with the computing system via a telemetry link.
